(19) United States
(12) Patent Application Publication
(10) Pub. No.: US 2022/0191636 A1
(43) Pub. Date: Jun. 16, 2022

(54) AUDIO SESSION CLASSIFICATION

(71) Applicant: Hewlett-Packard Development Company, L.P., Spring, TX (US)

(72) Inventors: Sunil Ganpat Bharitkar, Palo Alto, CA (US); Andre da Fonte Lopes da Silva, Palo Alto, CA (US); Walter Flores Pereira, Palo Alto, CA (US)

(73) Assignee: Hewlett-Packard Development Company, L.P., Spring, TX (US)

(21) Appl. No.: 17/604,780

(22) PCT Filed: Sep. 4, 2019
(86) PCT No.: PCT/US2019/049466

§ 371 Date: Oct. 19, 2021

(51) Int. Cl. H04S 3/00; G06K 9/62

(52) U.S. Cl. CPC H04S 3/006; G06K 9/6267

(57) ABSTRACT

Examples of methods for audio session classification are described herein. In some examples, a method may include determining, at a first classification stage, whether an audio session is classifiable with predetermined criteria. In some examples, the method may include classifying, at a second classification stage, the audio session based on a machine learning analysis of metadata in a case that the audio session is not classifiable at the first classification stage.

### BACKGROUND

Electronic technology has advanced to become virtually ubiquitous in society and has been used to improve many activities in society. For example, electronic devices are used to perform a variety of tasks, including work activities, communication, research, and entertainment. Electronic technology is often utilized to present media. For instance, computing devices may be utilized to present media that is streamed over a network. Electronic technology is also utilized to provide communication in the form of email, instant messaging, video conferencing, and Voice over Internet Protocol (VoIP) calls.

### BRIEF DESCRIPTION OF THE DRAWINGS

FIG. 1 is a flow diagram illustrating an example of a method for audio session classification;

FIG. 2 is a flow diagram illustrating an example of a method for audio session classification;

FIG. 3 is a block diagram of an example of an apparatus that may be used in audio session classification; and

FIG. 4 is a block diagram illustrating an example of a computer-readable medium for audio session classification.

### DETAILED DESCRIPTION

Electronic devices may be utilized to access and/or present media. Electronic devices are devices that include electronic circuitry. Media is audio content (e.g., sound, music, voice, etc.), visual content (e.g., digital images, text, etc.), or a combination thereof (e.g., audio-visual content such as videos). Multimedia is a combination of media. For example, multimedia may be a combination of visual content with audio content (e.g., movies, shows, music videos, lyric videos, etc.). A source is an entity that provides content. Some multimedia sources (e.g., Internet websites, online platforms, local applications, etc.) may provide movies, music (e.g., music without visual content and/or music with visual content), and/or user-generated content. Examples of sources may include Netflix, Amazon Prime Video, YouTube, iTunes, Microsoft Store, Smedio, Cyberlink, Windows Media Player, VideoLAN Client (VLC) media player, Mozilla-Firefox, Edge, Chrome, Internet Explorer, Lync, Zoom, Skype, etc. For instance, YouTube, Vimeo, and Youku are examples of sources that provide movies, music, and user-generated content.

As used herein, “surround content” is audio-visual content (e.g., motion pictures, TV shows, videos, broadcast sports videos recorded with multiple microphones, etc.) with audio originally formatted for reproduction with more than two speakers. For example, surround content may be audio-visual content originally formatted for surround sound (e.g., 5.1-channel surround sound, 7.1-channel surround sound, etc.) or object-based audio (e.g., 9.1-channel surround sound). In some examples, “surround content” may be provided from a source without the original audio formatting. For instance, surround content may have been originally formatted with 5.1-channel surround sound but may be provided from a streaming platform that provides audio encoded with two channels (e.g., stereo sound). As used herein, “stereo content” is audio content with or without visual content, with the audio content originally formatted for reproduction with two channels or speakers (e.g., stereo sound). In some examples, “stereo content” may be provided from a source without the original audio formatting. For instance, stereo content may have been originally formatted with stereo sound but may be provided from a streaming platform that provides audio encoded with surround sound (e.g., 5.1-channel, 7.1-channel, etc.) or object-based audio. As used herein “monophonic content” is audio content with or without visual content, with the audio content originally formatted for reproduction with one channel. In some examples, monophonic content may include communicated voice, which is data that communicates a voice or voices in a phone call, VoIP call, video call, conference call, voice message, etc. While “surround content,” “stereo content,” and “monophonic content” are utilized as classifications, each of the classifications may include a variety of content. For example, a “surround content” classification may include speech and/or musical audio in some cases, a “stereo content” classification may include motion picture audio and/or speech in some cases, and/or a “monophonic content” classification may include motion picture audio and/or musical audio in some cases. As used herein, the term “movie” may be used interchangeably with the term “surround content,” the term “music” may be used interchangeably with the term “stereo content,” and the term “voice” may be used interchangeably with the term “monophonic content.”

It may be beneficial to classify media as movie, music, or voice. For example, classifying media may be utilized to preserve artistic intent while rendering audio or audio-visual content. For example, movies may be created with 5.1-channel surround sound or object-based audio, while music (e.g., audio content with or without accompanying visual content) may be formatted in stereo before being encoded and transmitted to end consumer audio-visual (AV) devices such as televisions (TVs), set-top boxes, audio/video receivers (AVRs), personal computers (PCs), and smart speakers. One issue is that an electronic device may utilize a spatial rendering engine that erroneously upmixes stereo music to 5.1 channels and presents the music with discrete 5.1-channel surround sound speakers or headphones. Other erroneous upmixing may result in presenting originally formatted stereo audio in 7.1-channel surround sound or 9.1 object-based audio. Erroneous upmixing may result in the loss of artistic intent and/or the introduction of spatial and/or timbre artifacts in music. Another issue that may occur is that an electronic device may present movies in stereo sound, which may lose the benefits of surround sound or object-based audio. Accordingly, it may be beneficial to classify media as a movie, music, or voice. Classifying media may also be beneficial for multimedia indexing and/or retrieval. Automatically classifying media may be beneficial by avoiding manual user selection of a media classification. For instance, classifying media may be utilized to enable automatic selection of settings (e.g., audio reproduction settings) without user intervention.

Throughout the drawings, identical reference numbers may designate similar, but not necessarily identical, elements. Similar numbers may indicate similar elements. When an element is referred to without a reference number, this may refer to the element generally, without necessary limitation to any particular figure. The figures are not necessarily to scale, and the size of some parts may be exaggerated to more clearly illustrate the example shown. Moreover, the drawings provide examples and/or implementations in accordance with the description; however, the description is not limited to the examples and/or implementations provided in the drawings.

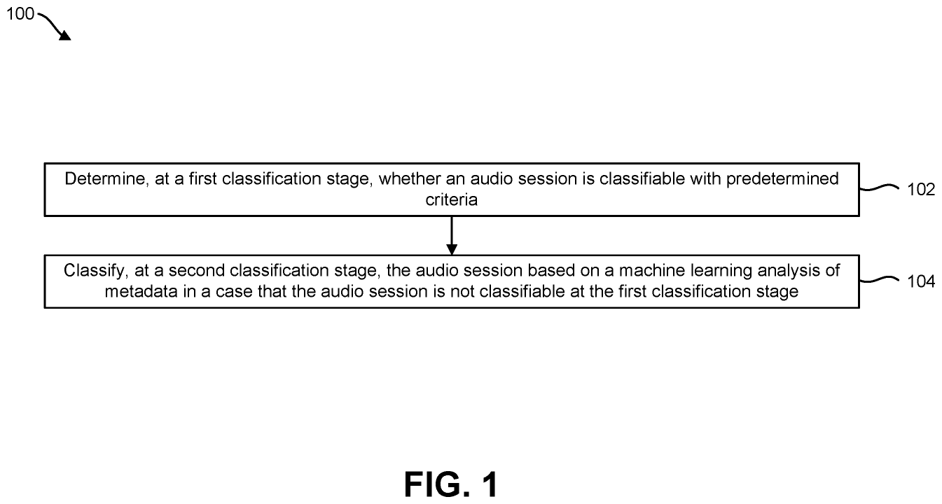

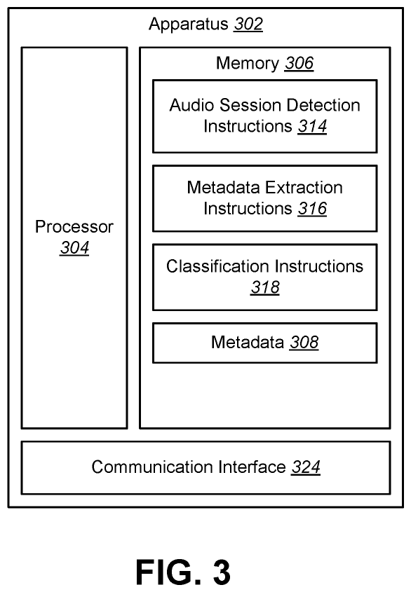

FIG. 1 is a flow diagram illustrating an example of a method 100 for audio session classification. The method 100 and/or a method 100 element or elements may be performed by an apparatus (e.g., electronic device, computing device, TV, set-top box, AVR, PC, smart speakers, home theater, media server, etc.). For example, the method 100 may be performed by the apparatus 302 described in connection with FIG. 3.

The apparatus may determine 102, at a first classification stage, whether an audio session is classifiable with a predetermined criterion or criteria. An audio session is an audio reproduction function or event. A first classification stage is a portion of a hierarchical classification model, where the hierarchical classification model includes a hierarchy or sequence of classification stages for classifying media. A first classification stage may include the predetermined criterion or criteria. The predetermined criterion or criteria is a predetermined rule or predetermined rules that indicate a classification (e.g., movie, music, or voice) based on a source of content from the audio session. In some examples, the predetermined criteria may indicate classifications for sources that provide one type of media. Examples of sources that provide one type of media may include Netflix for movies, Pandora for music, and Zoom or Skype for voice. In some examples, predetermined criteria may indicate that an audio session corresponding to Netflix is classified as a movie, an audio session corresponding to Pandora is classified as music, and an audio session corresponding to Zoom or Skype is classified as voice. The predetermined criteria may include other sources with corresponding classifications. In some examples, the first classification stage may be performed before another classification stage in the hierarchical classification model.

In some examples, determining 102 whether an audio session is classifiable at the first classification stage may include determining whether the predetermined criterion or criteria indicate a classification for the source of the audio session. For example, the first classification stage may include classifications for a number of sources. In a case that the first classification stage includes a classification for the source of the audio session, the audio session may be classifiable at the first stage. In a case that the first classification stage does not include a classification for the source of the audio session, the audio session may not be classifiable at the first stage.

The apparatus may classify 104, at a second classification stage, the audio session based on a machine learning analysis of metadata in a case that the audio session is not classifiable at the first classification stage. A second classification stage is a portion of the hierarchical classification model. The second classification stage may include performing the machine learning analysis of metadata of the audio session.

Machine learning is a technique where a machine learning model is trained to perform an operation based on examples or training data. For example, an apparatus may utilize a machine learning model that is trained to classify an audio session based on metadata of the audio session. Examples of machine learning models may include artificial neural networks (e.g., fully connected neural networks (FCNNs)), support vector machines, decision trees, clustering, k-nearest neighbor classification, etc. In some examples, the machine learning model may be trained with examples of metadata and corresponding classifications. Metadata is data about media. Examples of metadata that may be utilized include content duration, sample rate, video presence, bit depth, number of audio channels, video frame rate, etc. Other kinds of metadata may be utilized. In some examples, an element or elements of the method 100 may be omitted or combined. In some examples, the method 100 may provide an interception mechanism to access metadata from various sources, which may be utilized to automatically classify the media. In some examples, the classification may be performed without waveform-based analysis or classification. For example, it may be beneficial to classify media based on metadata (and not based on content waveforms, for instance) to reduce an amount of time or delay to classify the media (e.g., 6-8 milliseconds (ms) for machine learning model processing and approximately 50 ms for streaming and API processing), to reduce processing resource usage (e.g., approximately 1%) to classify the media, and/or to increase classification accuracy (e.g., 90% accuracy).

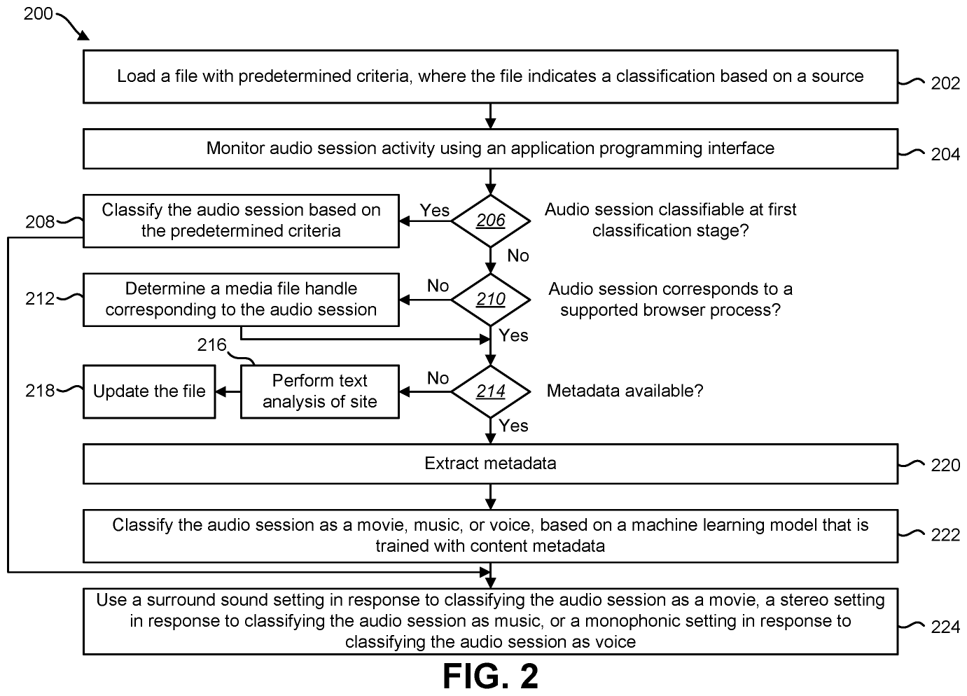

FIG. 2 is a flow diagram illustrating an example of a method 200 for audio session classification. The method 200 may be an example of the method 100 described in connection with FIG. 1. The method 200 and/or a method 200 element or elements may be performed by an apparatus (e.g., electronic device, computing device, server, 3D printer, etc.). For example, the method 200 may be performed by the apparatus 302 described in connection with FIG. 3.

The apparatus may load 202 a file with a predetermined criterion or criteria, where the file indicates a classification based on a source. For example, the apparatus may load 202 the file into memory. In some examples, the file may indicate associations or mappings between sources and classifications. In some examples, sources may be identified by process names and/or Uniform Resource Locators (URLs).

In some examples, the file may be a JavaScript Object Notation (JSON) file. The JSON file may include mappings from classifications (e.g., movie, music, and voice) to process names and URLs. For example, the mappings may include process names and website URLs that provide one type of media or audio session. In some examples, the file (e.g., JSON file) may be structured in a process portion and a URL portion. In some examples, the process portion may map a process name or names to a movie classification, a music portion that may map a process name or names to a music classification, and/or a voice portion that may map a process name or names (e.g., Lync, Teams, Zoom, etc., or variants thereof) to a voice classification. In some examples, the URL portion may map a URL or URLs (e.g., netflix.com, www.amazon.com, www.vudu.com, etc., or variants thereof) to a movie classification, a music portion that may map a URL or URLs (e.g., music.amazon.com, www.pandora.com, www.spotify.com, etc., or variants thereof) to a music classification, a voice portion that may map a URL or URLs (e.g., www.audible.com, etc., or variants thereof) to a voice classification, and/or a classifier portion that may be utilized to call a machine learning model to perform classification for a URL or URLs (e.g., youtube.com, dailymotion.com, etc., or variants thereof) based on metadata. In some examples, the first classification stage may correspond to classifications from the movie, music, and voice portions of the process portion and the URL portion. In some examples, the second classification stage may correspond to the classifier portion.

The apparatus may monitor 204 audio session activity using an application programming interface (API). For example, the apparatus may utilize an API or APIs of an operating system to monitor audio session activity. The API(s) may indicate when an audio session becomes active, inactive, or expired. An example of an API that may be utilized to monitor 204 audio session activity is Win32. In some examples, an audio session may be activated by a process on the apparatus (e.g., a process of a local application), where the process has a corresponding process name. In some examples, the audio session may be activated by a streaming website with a Uniform Resource Locator (URL). In some examples, an audio session may be active, inactive or expired. For instance, an audio session may become active when an application initiates streaming audio to a sound card. In some examples, an Operating System (OS) may notify a classification process to initiate classification when an audio session becomes active. In some examples, classification may be performed for active audio sessions.

The apparatus may determine 206 whether the audio session is classifiable at a first classification stage. In some examples, determining 206 whether the audio session is classifiable at the first classification stage may include determining whether the predetermined criterion or criteria indicate a classification for a source of the audio session. For example, when an audio session becomes active, the apparatus may determine whether a source of the audio session is listed with a classification in the file at the first classification stage of the hierarchical classification model. In some examples, the source may be indicated by a process name or a URL. For instance, the apparatus may identify the source with a process name and/or a URL associated with the audio session. The apparatus may look up and/or search the predetermined criterion or criteria (e.g., the file) for the process name and/or URL at the first classification stage. The source may be indicated in a case that the process name or URL is included in the predetermined criterion or criteria at the first classification stage. The audio session may be classifiable at the first classification stage in a case that the source is indicated at the first classification stage. The audio session may not be classifiable at the first classification stage in a case that the source is not indicated at the first classification stage.

In response to determining 206 that the audio session is classifiable at the first classification stage, the apparatus may classify 208 the audio session based on the predetermined criterion or criteria. For example, in a case that the predetermined criterion or criteria indicate a classification for the source of the audio session, the apparatus may classify 208 the audio session as a movie, music, or voice according to the classification of the predetermined criterion or criteria that matches the source (e.g., process name or URL). In an example, if a Microsoft Teams call is initiated, the apparatus may detect an active audio session and set the classification to voice in the first classification stage (without performing the second classification stage, for instance). In some examples, when an audio session becomes active, the apparatus may determine whether a corresponding process or streaming site that activated the audio session is listed in the predetermined criterion or criteria of a JSON file. In some examples, the application name or the streaming site URL may be matched to the corresponding classification. In some examples, the apparatus may use 224 a surround sound setting in response to classifying 208 the audio session as a movie, or a stereo setting in response to classifying 208 the audio session as music, or a monophonic (or stereo setting) in response to classifying 208 the audio session as voice. In some examples, a classification or classifications from the first classification stage may be utilized to train a machine learning model. For example, the machine learning model may be continuously trained and/or updated after deployment.

In response to determining 206 that the audio session is not classifiable at the first classification stage, the apparatus may determine 210 whether the audio session corresponds to a supported browser process. For example, the apparatus may determine 210 whether the process name associated with the audio session corresponds to a supported browser application (e.g., Internet Explorer, Chrome, Firefox, Edge, etc.). For instance, the apparatus may look up and/or search for the process name in a set of process names corresponding to browser applications. The audio session may correspond to a supported browser process in a case that the process name is included in the set of process names corresponding to browser applications. The audio session may not correspond to a supported browser process in a case that the process name is not included in the set of process names corresponding to browser applications.

In response to determining that the audio session does not correspond to a supported browser process, the apparatus may determine 212 a media file handle corresponding to the audio session. For example, the apparatus may obtain a list of open media file handles and identify a media file handle or handles corresponding to the audio session. In some examples, the media file handle(s) may be sent to a remote device (e.g., server) for improving classification.

The apparatus may determine 214 whether metadata is available. In a case that the audio session corresponds to a supported browser process, the apparatus may download a page document using the URL and determine whether metadata associated with the audio session is included in the page document. In a case that the audio session does not correspond to a supported browser process, the apparatus may utilize the media file handle to determine whether metadata is associated with the audio session.

In response to determining 214 that metadata is not available, and if the process is a supported browser process, the apparatus may perform 216 text analysis of a site. For example, the apparatus may analyze text from the page document to search for terms such as “movie,” “film,” “song,” and/or other terms that may indicate whether the audio session corresponds to a movie, music, or voice. In some examples, the apparatus may classify the audio session based on the text analysis. In some examples, text terms may be extracted and/or utilized to classify the audio session in a case that metadata is not available. The apparatus may update 218 the file. For example, the apparatus may add information (e.g., a URL) to the file (e.g., JSON file) that may be utilized to classify a subsequent audio session. In some examples, the text analysis may be sent to a remote device (e.g., server) for improving classification.

In response to determining 214 that metadata is available, the apparatus may extract 220 the metadata. In some examples, the apparatus may read and/or store the metadata from the page document corresponding to the audio session. In some examples, the apparatus may read and/or store the metadata associated with the media file handle.

In some examples, metadata may include content-related descriptors in encoded music and visual media content (e.g., in Moving Picture Experts Group-4 (MP4) files or other files) that may be extracted by decoding the content or a portion of the content. In some examples, metadata may include two categories: a first category that describes how media is stored and a second category that describes the substance of the media. For example, the first category may include video/audio codec, content duration, video/audio bitrate, bit-depth, sample rate for audio, and/or frames/second (e.g., for moving pictures), etc. The second category may include language, title, artist (if applicable), album cover image, etc. Different containers may include different metadata descriptors. A container is a file that includes content (e.g., audio content and/or visual content) and metadata. While the metadata descriptors may be different between different containers (e.g., MP4, QuickTime Movie (MOV), Audio Video Interleave (AVI), etc.), some metadata descriptors may be included in a variety of containers. For example, some metadata descriptors may include content duration (e.g., running time or length of the content), sample rate (e.g., sample rate of audio), video presence (e.g., presence or absence of video), bit depth (e.g., audio bit depth), number of channels (e.g., audio channel count), video frame rate, etc. It may be beneficial to utilize a subset of available metadata to efficiently train a machine learning model. For example, a feature vector for the machine learning model may include content duration, sample rate, video presence, bit depth, and/or number of channels.

The apparatus may classify 222 the audio session as a movie, music, or voice based on a machine learning model. For example, the apparatus may provide the metadata to the machine learning model, which may produce a classification of the audio session as a movie, music, or voice. In some examples, the machine learning model may be trained with content metadata. For example, the machine learning model may have been previously trained using training metadata, where the training metadata includes content duration, sample rate, video presence, bit depth, and/or number of channels, etc. In some examples, the machine learning model may be periodically, repeatedly, and/or continuously updated and/or trained (with results and/or user feedback corresponding to the first classification stage and/or the second classification stage).

The apparatus may use 224 a surround sound setting in response to classifying the audio session as a movie. For instance, in a case that the audio session is classified as a movie, the apparatus may use 224 a surround sound setting. In some examples, using a surround sound setting may include processing and/or presenting the audio session using synthetic surround sound. For instance, the apparatus may upmix the audio session to more than two channels and/or present the audio using more than two speakers.

The apparatus may use 224 a stereo setting in response to classifying the audio session as music. For instance, in a case that the audio session is classified as music, the apparatus may use 224 a stereo setting. In some examples, using a stereo setting may include processing and/or presenting the audio session using two channels and/or two speakers.

The apparatus may use 224 a monophonic setting in response to classifying the audio session as voice. For instance, in a case that the audio session is classified as voice, the apparatus may use 224 a monophonic setting. In some examples, using a monophonic setting may include processing (e.g., speech enhancing filtering) and/or presenting the audio session using one audio channel comprising voice from a talker or multiple talkers. In some examples, the apparatus may use 224 a stereo setting in response to classifying the audio session as voice. In some examples, an element or elements of the method 200 may be omitted or combined.

FIG. 3 is a block diagram of an example of an apparatus 302 that may be used in audio session classification. The apparatus 302 may be an electronic device, such as a PC, server computer, TV, set-top box, AVR, smart speakers, home theater, media server, etc.). The apparatus 302 may include and/or may be coupled to a processor 304 and/or a memory 306. The apparatus 302 may include additional components (not shown) and/or some of the components described herein may be removed and/or modified without departing from the scope of this disclosure.

The processor 304 may be any of a central processing unit (CPU), a digital signal processor (DSP), a semiconductor-based microprocessor, graphics processing unit (GPU), field-programmable gate array (FPGA), an application-specific integrated circuit (ASIC), and/or other hardware device suitable for retrieval and execution of instructions (e.g., executable code) stored in the memory 306. The processor 304 may fetch, decode, and/or execute instructions stored in the memory 306. In some examples, the processor 304 may include an electronic circuit or circuits that include electronic components for performing a function or functions of the instructions. In some examples, the processor 304 may be implemented to perform one, some, or all of the functions, operations, elements, methods, etc., described in connection with one, some, or all of FIGS. 1-4.

The memory 306 is an electronic, magnetic, optical, and/or other physical storage device that contains or stores electronic information (e.g., instructions and/or data). The memory 306 may be, for example, Random Access Memory (RAM), Electrically Erasable Programmable Read-Only Memory (EEPROM), a storage device, an optical disc, and/or the like. In some examples, the memory 306 may be volatile and/or non-volatile memory, such as Dynamic Random Access Memory (DRAM), EEPROM, magnetoresistive random-access memory (MRAM), phase change RAM (PCRAM), memristor, flash memory, and/or the like. In some implementations, the memory 306 may be a non-transitory tangible machine-readable storage medium, where the term “non-transitory” does not encompass transitory propagating signals. In some examples, the memory 306 may include multiple devices (e.g., a RAM card and a solid-state drive (SSD)).

In some examples, the apparatus 302 may include a communication interface 324 through which the processor 304 may communicate with a device or devices (e.g., speakers, headphones, monitors, TVs, display panels, etc.). In some examples, the apparatus 302 may be in communication with (e.g., coupled to, have a communication link with) speakers. In some examples, the apparatus 302 may be a PC, server computer, TV, set-top box, AVR, smart speakers, home theater, media server, etc.

In some examples, the communication interface 324 may include hardware and/or machine-readable instructions to enable the processor 304 to communicate with the external device or devices. The communication interface 324 may enable a wired and/or wireless connection to the external device or devices. In some examples, the communication interface 324 may include a network interface card and/or may also include hardware and/or machine-readable instructions to enable the processor 304 to communicate with various input and/or output devices. Examples of output devices include a printer, a 3D printer, a display, etc. Examples of input devices include a keyboard, a mouse, a touch screen, etc., through which a user may input instructions and/or data into the apparatus 302. In some examples, the communication interface 324 may enable the apparatus 302 to communicate with a device or devices (e.g., servers, computers, etc.) over a network or networks. Examples of networks include the Internet, wide area networks (WANs), local area networks (LANs), personal area networks (PANs), and/or combinations thereof. For example, the apparatus 302 may send requests for media to a website or websites on the Internet and/or may receive a media stream or streams from the website(s).

In some examples, the memory 306 of the apparatus 302 may store audio session detection instructions 314, metadata extraction instructions 316, classification instructions 318, and/or metadata 308. In some examples, the memory 306 may include a training data set for training a machine learning model. The audio session detection instructions 314 are instructions for detecting activation of an audio session. For example, the processor 304 may execute the audio session detection instructions 314 to detect when an audio session becomes active to present media.

The metadata extraction instructions 316 are instructions for extracting metadata corresponding to an audio session. For example, the processor 304 may execute the metadata extraction instructions 316 to extract metadata corresponding to an audio session. In some examples, the processor 304 may execute the metadata extraction instructions 316 to extract metadata from a page document corresponding to a website that is providing a media stream. In some examples, the processor 304 may execute the metadata extraction instructions 316 to extract metadata associated with a media file handle corresponding to a local process. The extracted metadata may be stored in the memory 306 as metadata 308. In some examples, the metadata 308 may include data (e.g., descriptors) indicating content duration, sample rate, video presence, bit depth, and/or number of channels for an activated audio session or audio session(s).

The classification instructions 318 are instructions for classifying the audio session. In some examples, the classification instructions 318 may include instructions for classifying the audio session using predetermined criterion or criteria at a first classification stage and instructions for classifying the audio session using a machine learning model at a second classification stage. In some examples, the processor 304 may execute the classification instructions 318 to classify the audio session. For instance, the processor 304 may execute the classification instructions 318 to provide the metadata to a machine learning model to classify the audio session in response to determining that the audio session is not classifiable with a predetermined criterion or criteria. In some examples, the machine learning model may be trained using data indicating content duration, sample rate, video presence, bit depth, and/or number of channels. For example, the machine learning model may be trained using examples of classified media with corresponding content duration, sample rate, video presence, bit depth, and/or number of channels corresponding to classified media. In some examples, the training may be performed by the apparatus 302. In some examples, the training may be performed by another device and the trained machine learning model may be provided to the apparatus 302.

In some examples, content duration metadata may be utilized for the machine learning model. For example, content duration metadata may be characterized by a content-dependent distribution f_{c}(x|a,b), where c represents the classification (e.g., movie, music, or voice), x is the content duration in seconds, and a and b are parameters of the distribution. In some examples, samples representing the content duration metadata may be generated in accordance with the distribution. In some examples, the content duration metadata may be synthetically generated to train a machine learning model. It may be beneficial to synthetically generate the content duration metadata to avoid sampling a large number of media. In some examples, it may be beneficial to synthetically generate the content duration metadata to enable adjusting the distribution parameters to improve classification accuracy of a machine learning model. For instance, samples of content duration may be obtained corresponding to music, movie trailers, movies, short form films, long form films, TV shows, broadcast sports, etc. Some examples of the content duration metadata distribution may include a Weibull distribution (based on asymmetric nature of the independent variable being modeled, for instance) and a Gaussian distribution. For example, a Weibull distribution may be parameterized by (α, β) on a domain t (in seconds, for example) that control the position and the shape of the distribution, and may be expressed in accordance with Equation (1).

$$f ( t \vert α , β ) = \frac{β}{α} {( \frac{t}{α} )}^{β - 1} {e}^{{( - \frac{t}{α} )}^{β}} \qquad ( 1 )$$

In Equation (1), f (t|α, β) is a Weibull distribution, where t is time, and α and β are parameters that control the position and shape of the distribution. For instance, the content-dependent distribution f_{c} (x|a, b) may be an example of the distribution f (t|α, β).

A Gaussian distribution may be expressed in accordance with Equation (2).

$$f ( t \vert α , β ) = \frac{1}{\sqrt{2 π} β} {e}^{- {( \frac{t - α}{β} )}^{2}} \qquad ( 2 )$$

In Equation (2), f (t|α, β) is a Gaussian distribution, where t is time, and α and β are parameters that control the position and shape of the distribution. For instance, the content-dependent distribution f_{c} (x|a, b) may be an example of the distribution f (t|α, β). In some examples, metadata (e.g., content duration metadata) generated with the distribution may be utilized to train a machine learning model for classifying the audio session. For instance, a distribution or distributions of metadata may be generated for each classification (e.g., movie, music, voice) to produce a training data set.

In some examples, feature vectors may be generated to train a machine learning model. For example, feature vectors may be generated that include one of three sample rates corresponding to 48 kilohertz (kHz), 44.1 kHz, and 16 kHz, which may be used for movies (e.g., audio-visual content), music, user-generated content, and/or voice (e.g., VoIP calls). In some examples, each of the feature vectors may include a binary variable indicating the presence or absence of video. In some examples, each of the feature vectors may include a parameter corresponding to a quantized bit-depth of 16 bits/sample (for voice, music, or movies, for instance), 20 bits/sample (for broadcast content, for instance), and 24 bits/sample (for movies, for instance). In some examples, each of the feature vectors may include a number of channels (e.g., 1 for monophonic content, 2 for stereo content, or 6 for surround sound content).

In some examples, the machine learning model may be a multilayered fully connected neural network (FCNN). For instance, an FCNN may have an approximation property that enables approximating arbitrary functions (e.g., non-linear boundaries). In some examples, the multilayered FCNN may include two hidden layers, with 30 and 40 neurons respectively, and an output layer of three neurons corresponding to the classifications. In some examples, the training of the multilayer FCNN weights w may be performed with a weight update rule involving the first derivative of network error e with respect to weights and biases (according to a Jacobian matrix J) being set to in accordance with Equation (3).

w(k+1)=w(k)−(J^{T}J+μI)⁻¹J^{T}e (3)

In Equation (3), w(k) is a weight with index k, J is the Jacobian matrix, T denotes transpose, μ is a regularization parameter to allow stable inversion of the matrix (J^{T}J), and e is the network error.

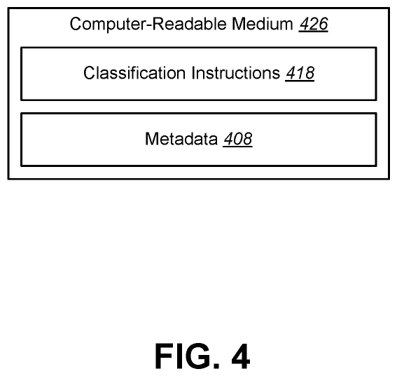

FIG. 4 is a block diagram illustrating an example of a computer-readable medium 426 for audio session classification. The computer-readable medium is a non-transitory, tangible computer-readable medium 426. The computer-readable medium 426 may be, for example, RAM, EEPROM, a storage device, an optical disc, and the like. In some examples, the computer-readable medium 426 may be volatile and/or non-volatile memory, such as DRAM, EEPROM, MRAM, PCRAM, memristor, flash memory, and the like. In some implementations, the memory 306 described in connection with FIG. 3 may be an example of the computer-readable medium 426 described in connection with FIG. 4.

The computer-readable medium 426 may include code (e.g., data and/or instructions). For example, the computer-readable medium 426 may include classification instructions 418 and/or metadata 408. The metadata 408 may be data corresponding to media for an audio session or audio sessions.

The classification instructions 418 include code to cause a processor to classify an audio session in accordance with a hierarchy. The hierarchy may include a first classification stage to classify in accordance with predetermined criterion or criteria and a second classification stage to classify using a machine learning model based on metadata 408 corresponding to the audio session. The second classification stage may be after the first classification stage. In some examples, the second classification stage may be performed in response to determining that the audio session is not classifiable at the first classification stage. For instance, the first classification stage may be performed first in order to reduce processing associated with the machine learning model for cases where classification is unambiguous for a source. In some examples, the audio session may be classified as described in connection with FIG. 1, FIG. 2, and/or FIG. 3.

While various examples of systems and methods are described herein, the systems and methods are not limited to the examples. Variations of the examples described herein may be implemented within the scope of the disclosure. For example, operations, functions, aspects, or elements of the examples described herein may be omitted or combined.

1. A method, comprising:
determining, at a first classification stage, whether an audio session is classifiable with predetermined criteria; and
classifying, at a second classification stage, the audio session based on a machine learning analysis of metadata in a case that the audio session is not classifiable at the first classification stage.

2. The method of claim 1, further comprising loading a file with the predetermined criteria, wherein the file indicates a classification based on a source of content for the audio session.

3. The method of claim 1, further comprising monitoring audio session activity using an application programming interface.

4. The method of claim 1, wherein determining whether the audio session is classifiable at the first classification stage comprises determining whether the predetermined criteria indicate a classification for a source of the audio session.

5. The method of claim 4, wherein, in response to determining that a second audio session is classifiable at the first classification stage, the method comprises classifying the second audio session based on the predetermined criteria.

6. The method of claim 1, wherein, in response to determining that the audio session is not classifiable at the first classification stage, the method comprises determining whether the audio session corresponds to a supported browser process.

7. The method of claim 6, wherein, in response to determining that the audio session does not correspond to a supported browser process, the method comprises determining a media file handle corresponding to the audio session.

8. The method of claim 1, wherein classifying the audio session based on the machine learning analysis comprises classifying the audio session as surround content, stereo content, or monophonic content.

9. The method of claim 1, wherein the machine learning analysis is performed using a machine learning model that is trained with content duration metadata.

10. The method of claim 1, further comprising using a surround sound setting in response to classifying the audio session is classified as surround content.

11. The method of claim 1, further comprising using a stereo sound setting in response to classifying the audio session is classified as stereo content.

12. An apparatus, comprising:
a memory; and
a processor coupled to the memory, wherein the processor is to:
detect activation of an audio session;
extract metadata corresponding to the audio session; and
provide the metadata to a machine learning model to classify the audio session in response to determining that the audio session is not classifiable with predetermined criteria.

13. The apparatus of claim 12, wherein the machine learning model is trained using data indicating content duration, sample rate, video presence, bit depth, or number of channels.

14. A non-transitory tangible computer-readable medium storing executable code, comprising:
code to cause a processor to classify an audio session in accordance with a hierarchy, wherein the hierarchy comprises a first classification stage to classify in accordance with predetermined criteria, and a second classification stage to classify using a machine learning model based on metadata corresponding to the audio session.

15. The computer-readable medium of claim 14, wherein the second classification stage is after the first classification stage.
